(19) United States
(12) Patent Application Publication
(10) Pub. No.: US 2016/0147967 A1
(43) Pub. Date: May 26, 2016

(54) MEDICAL SUPPORT DEVICE

(71) Applicant: FUJIFILM Corporation, Tokyo (JP)

(72) Inventors: Yasunori OHTA, Ashigarakami-gun (JP); Satoshi UEDA, Tokyo (JP); Ryosuke USAMI, Tokyo (JP)

(73) Assignee: FUJIFILM Corporation, Tokyo (JP)

(21) Appl. No.: 15/010,654

(22) Filed: Jan. 29, 2016

Related U.S. Application Data
(63) Continuation of application No. PCT/JP2014/070031, filed on Jul. 30, 2014.

(30) Foreign Application Priority Data
Jul. 31, 2013 (JP) 2013-159929

(51) Int. Cl. G06F 19/00; G06F 3/0481

(52) U.S. Cl. CPC G06F 19/3406; G06F 3/0481; G06F 19/322

(57) ABSTRACT

The medical support device is detachably provided in a cradle device installed inside an ambulance, and is used in a state in which the medical support device is detached from the cradle device and a state in which the medical support device is attached to the cradle device. The medical support device operates in a first support mode when the medical support device is detached from the cradle device, and operates in a second support mode when the medical support device is attached to the cradle device. The medical support device displays a triage support screen for supporting triage on a display in the first support mode. Further, the medical support device displays any one of a monitoring support screen for monitoring an electrocardiogram, a FAST support screen for supporting a FAST, and a selection support screen for supporting selection of a transport destination on the display in the second support mode.

### CROSS-REFERENCE TO RELATED APPLICATIONS

This application is a Continuation of PCT International Application No. PCT/JP2014/070031 filed on Jul. 30, 2014, which claims priority under 35 U.S.C §119(a) to Japanese Patent Application No. 2013-159929 filed Jul. 31, 2013. The above application is hereby expressly incorporated by reference, in its entirety, into the present application.

### BACKGROUND OF THE INVENTION

1. Field of the Invention

The present invention relates to a portable medical support device that supports emergency medical care.

2. Description Related to the Prior Art

A medical support device configured as a mobile workstation or the like that is put at a disaster site or the like and supports emergency medical care has been known (see JP2007-181004A). This medical support device includes a large number of functions necessary for emergency medical care. Specifically, the functions include a function of measuring blood pressure, heart rate, and body temperature, a triage function, a chart creation function of generating an electronic chart in which a treatment policy is defined after the triage, a chart distribution function of distributing an electronic chart to a disaster countermeasures office or the like, a request function of a request for transport of patients or for provision of medicine, and the like. Here, the triage refers to determining a degree of emergency or a degree of severity of disease or injury for each patient to determine a priority of treatment such as curing. The triage function included in the medical support device described in JP2007-181004A refers to a function of recording the priority determined for each patient based on data obtained using a measuring function or opinions input by a doctor or the like on a triage tag made of an IC tag, and issuing the triage tag on which the priority has been recorded.

Since the medical support device in JP2007-181004A is multifunctional, the medical support device can be utilized in many situations in emergency medical care. However, operations such as a function selection operation may be cumbersome due to the multifunctionality, and ease of use may be bad in situations requiring rapidity.

Treatments performed in the emergency medical care are roughly classified into primary treatment and secondary treatment. The primary treatment is treatment that is performed on an occurrence site of an accident or disaster (treatment that is performed at a dispatch destination of an ambulance at which emergency medical care is first required), and includes, for example, triage or life-saving treatment (artificial respiration or heart massage). Meanwhile, the secondary treatment is treatment that is performed after the primary treatment, and is treatment that is performed during emergency transport or in a temporary medical facility at the occurrence site. Prompt action is required in the primary treatment, and various treatments according to a change in symptoms of a patient are required in the secondary treatment.

Therefore, performance required for a medical support device in each step of the primary treatment and the secondary treatment also changes according to a difference in nature between the primary treatment and the secondary treatment. Specifically, in a step of the primary treatment, it is preferable for the minimal amount of necessary functions rather than multiple functions to be realized by a simple operation, and in a step of the secondary treatment, there is some time margin as compared to the primary treatment, and accordingly, it is preferable for multiple functions to be provided even though complexity of an operation is somewhat sacrificed.

In JP2007-181004A, problems caused due to the difference in nature between the primary treatment and the secondary treatment, or solutions thereto have not been considered. Therefore, operations such as a function selection operation become cumbersome, and ease of use may be bad in situations requiring rapidity.

### SUMMARY OF THE INVENTION

An object of the present invention is to provide a medical support device capable of performing appropriate support in consideration of a difference in nature between individual treatments of emergency medical care, such as primary treatment and secondary treatment.

To achieve the above object, a medical support device of the present invention is a portable medical support device that supports emergency medical care, and includes a display control unit and a mode switching unit. The display control unit is a display control unit that displays a medical support screen for supporting the emergency medical care on a display, and performs control for displaying any one of a plurality of medical support screens grouped into first and second groups in advance. The mode switching unit switches an operation mode between a first support mode of displaying a first medical support screen that is the medical support screen belonging to the first group and a second support mode of displaying a second medical support screen that is the medical support screen belonging to the second group.

Treatment in the emergency medical care may be classified into primary treatment and secondary treatment executed after the primary treatment, a medical support screen necessary for the primary treatment may be set as the first medical support screen, and a medical support screen necessary for the secondary treatment may be set as the second medical support screen.

The primary treatment may be treatment that is performed at a dispatch destination of an ambulance in which the emergency medical care is first required.

The secondary treatment may be treatment that is performed while a patient subjected to the primary treatment is transported to a medical facility by an ambulance.

The medical support device may be detachably provided in the cradle device installed inside the ambulance, and the medical support device may include an attachment and detachment detection unit that detects attachment and detachment of the medical support device to and from the cradle device. The mode switching unit may perform switching of the operation mode in accordance with the attachment and detachment of the medical support device to and from the cradle device.

The mode switching unit may switch the operation mode to the first support mode in the case where the medical support device is detached from the cradle device, and may switch the operation mode to the second support mode in the case where the medical support device is attached to the cradle device.

The first medical support screen may include a medical support screen for supporting triage for determining a priority of treatment of a patient.

The first medical support screen may include a medical support screen for supporting life-saving treatment of a patient.

The second medical support screen may include a monitoring support screen for supporting monitoring of vital information of a patient.

The medical support device may be capable of receiving the vital information transmitted from a measurement device for measuring the vital information, and the display control unit may update the monitoring support screen based on the received vital information.

The second medical support screen may include a FAST support screen for supporting FAST that is a quick and simple inspection method performed using an ultrasonic inspection device.

The FAST support screen may be a screen, in which positions of six places including pericardial space, Morrison fossa, right thoracic cavity, surroundings of the spleen, left thoracic cavity, and Douglas fossa that are inspection portions in the FAST are marked in a schema diagram as a schematic diagram of a human body.

The medical support device may be capable of receiving an ultrasonic image from the ultrasonic inspection device, and the display control unit may display the received ultrasonic image on the FAST support screen.

The second medical support screen may include a selection support screen for supporting selection of a medical facility as a transport destination.

The medical support device may include a position detection unit for receiving radio waves from a GPS satellite so as to acquire current position information, and the display control unit may display a selectable medical facility on the selection support screen based on the current position information acquired by the position detection unit.

The first medical support screen may be a non-updatable screen in which display content of the screen is not updated regardless of whether or not new information is received, and the second medical support screen may be an updatable screen in which display content of the screen is updated based on received information each time new information is received.

A camera for photographing a site of a dispatch destination of an ambulance in which the emergency medical care is first required in the first support mode, and photographing a patient that is being transported to a medical facility by the ambulance in the second support mode may be provided.

At least some of the first medical support screens belonging to the first group may be set in the second group in an overlapping manner.

Executable support functions may be limited in the first support mode more than in the second support mode.

According to the present invention, since the first medical support screen is displayed in the first support mode and the second medical support screen is displayed in the second support mode, it is possible to provide the medical support device capable of performing appropriate support in consideration of a difference in nature between individual treatments of emergency medical care, such as the primary treatment and the secondary treatment.

### BRIEF DESCRIPTION OF DRAWINGS

For more complete understanding of the present invention, and the advantage thereof, reference is now made to the subsequent descriptions taken in conjunction with the accompanying drawings, in which:

FIG. 1 is a schematic diagram illustrating a configuration of a medical support system;

FIG. 2 is a schematic configuration diagram of a medical support device;

FIG. 3 is a diagram illustrating functions of the medical support device;

FIG. 4 is an illustrative diagram illustrating a state in which medical support screens displayed according to an operation mode are different from each other;

FIG. 5 is an illustrative diagram illustrating a triage support screen;

FIG. 6 is an illustrative diagram illustrating a monitoring support screen;

FIG. 7 is an illustrative diagram illustrating a FAST support screen; and

FIG. 8 is an illustrative diagram illustrating a selection support screen.

### DESCRIPTION OF THE PREFERRED EMBODIMENTS

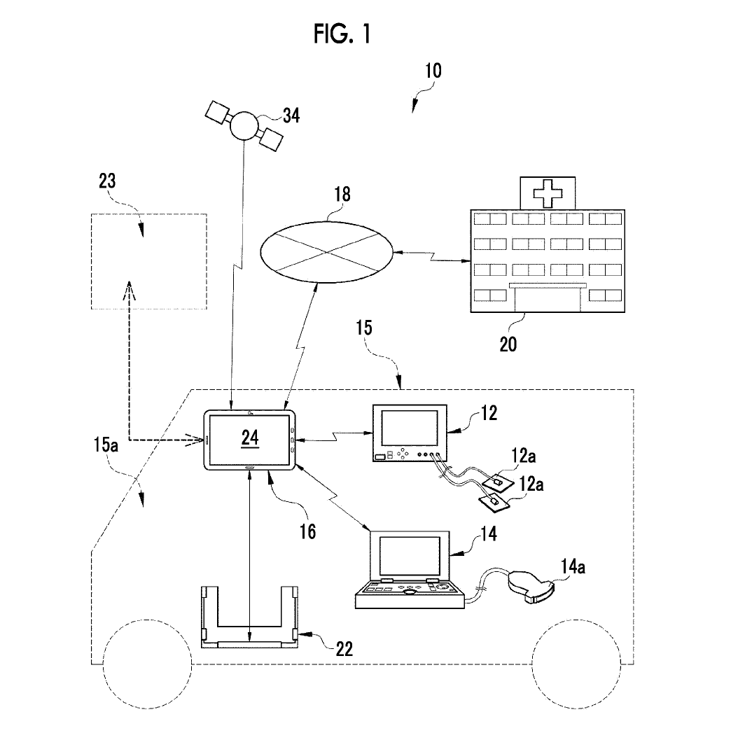

In FIG. 1, a medical support system 10 includes an electrocardiograph (measurement device) 12, an ultrasonic inspection device 14, and a medical support device 16. The electrocardiograph (measurement device) 12 and the ultrasonic inspection device 14 are installed in the inside 15a of an ambulance 15 (in the ambulance), and are communicatively connected to the medical support device 16 in a wired manner or a wireless manner. Further, the medical support device 16 is connected to a management center 20 via a known communication network 18, such as the Internet or a local area network (LAN).

The management center 20 is, for example, a regional medical center that generally controls a regional medical service. The electrocardiograph 12 includes an electrode 12a affixed to a patient. The electrocardiograph 12 detects an electrical signal of a heart of the patient via the electrode 12a, and transmits a detection result (electrocardiographic data) to the medical support device 16. The ultrasonic inspection device 14 includes an ultrasonic probe 14a that performs generation of the ultrasonic waves and reception of reflected waves. The ultrasonic inspection device 14 generates an ultrasonic image based on the reflected waves of the generated ultrasonic waves, and transmits the generated ultrasonic image to the medical support device 16.

The medical support device 16 is a portable medical support device. The medical support device 16 is, for example, a tablet computer, and is provided detachably in a cradle device 22. When the cradle device 22 is installed in the inside 15a of the ambulance 15 and the medical support device 16 is used in the inside 15a of the ambulance 15, the medical support device 16 is used in an attachment state in which the medical support device 16 is attached to the cradle device 22. When the medical support device 16 is used on the outside 23 of the ambulance 15 (outside the ambulance), the medical support device 16 is used in a detachment state in which the medical support device 16 is detached from the cradle device 22. The medical support device 16 operates with power supplied from a built-in battery (not illustrated) in a detachment state, and operates with power supplied from the outside via the cradle device 22 in an attachment state.

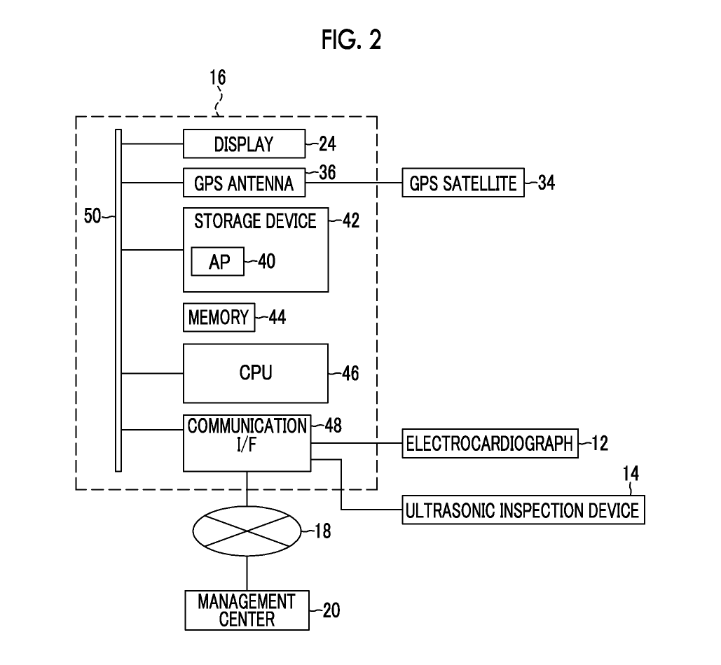

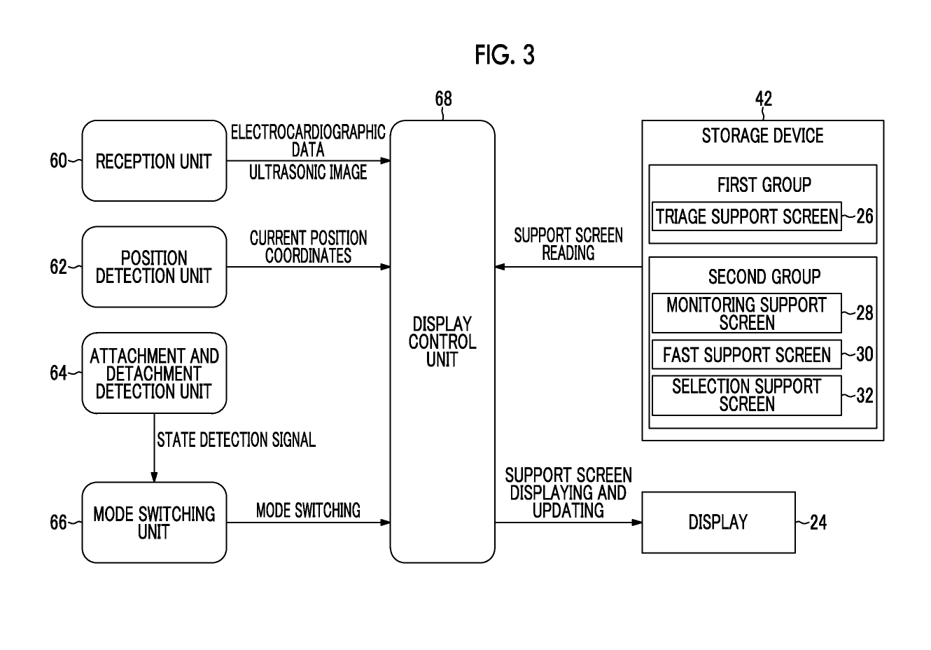

The medical support device 16 includes a touch panel display 24. The medical support device 16 enables various operation instructions to be input by a touch operation on the display 24 and displays medical support screens 26, 28, 30, and 32 (see FIGS. 3, and 5 to 8) to be described below on the display 24 to perform support for emergency medical care. Further, the medical support device 16 includes a global positioning system (GPS) antenna 36 (see FIG. 2) that receives radio waves from a GPS satellite 34, and has a position detection function of acquiring a current position based on the received radio waves.

As illustrated in FIG. 2, the medical support device 16 is configured by installing a control program such as an operating system, or an application program (AP) 40 for causing a computer to function as the medical support device 16 based on the tablet computer.

The medical support device 16 includes a storage device 42, a memory 44, a central processing unit (CPU) 46, and a communication I/F 48, in addition to the display 24 and the GPS antenna 36 described above, which are connected to each other via a data bus 50. The storage device 42 is, for example, a hard disk drive, or an internal storage built into a main body of the medical support device 16. A control program, an AP 40, and the medical support screen 26, 28, 30, and 32 are stored in the storage device 42 (see FIGS. 3 and 5 to 8).

The memory 44 is a work memory for a CPU 46 that performs a process. The CPU 46 generally controls each unit of the computer by loading a control program stored in the storage device 42 into the memory 44 and executing a process according to the program. The communication I/F 48 is an interface that performs transmission control with respect to the electrocardiograph 12, the ultrasonic inspection device 14, and the management center 20 via the communication network 18.

The AP 40 is a program for causing the computer to execute a support function of performing support in the emergency medical care. The CPU 46 generally controls respective units of the computer by loading the AP 40 stored in the storage device 42 into the memory 44 and executing the process according to the program.

As illustrated in FIG. 3, when the AP 40 starts up, the CPU 46 functions as a reception unit 60, a position detection unit 62, an attachment and detachment detection unit 64, a mode switching unit 66, and a display control unit 68 in cooperation with the memory 44 to perform a support process of performing support of emergency medical care.

The reception unit 60 receives the electrocardiographic data transmitted from the electrocardiograph 12 to the medical support device 16 and the ultrasonic image transmitted from the ultrasonic inspection device 14 to the medical support device 16, and inputs the received electrocardiographic data and the received ultrasonic image to the display control unit 68. The position detection unit 62 calculates current position coordinates of the medical support device 16 based on radio waves from the GPS satellite 34 received by the GPS antenna 36, and inputs the calculated current position coordinates to the display control unit 68.

The attachment and detachment detection unit 64 determines whether a supply source for power for the medical support device 16 is a built-in battery or an external power supply, detects whether the medical support device 16 is in an attachment state or a detachment state, and outputs a state detection signal indicating a state of the medical support device 16 to the mode switching unit 66. A method of detecting whether or not the medical support device 16 is attached to the cradle device 22 is not limited to a method of detection from the supply source for power. For example, various known methods such as a method of detecting a connection state between a terminal of the medical support device 16 and a terminal of the cradle device 22, and a method of providing, in the medical support device 16, a projection pressed and moved by the cradle device 22 when the medical support device 16 is attached to the cradle device 22 and detecting a state of the projection may be used.

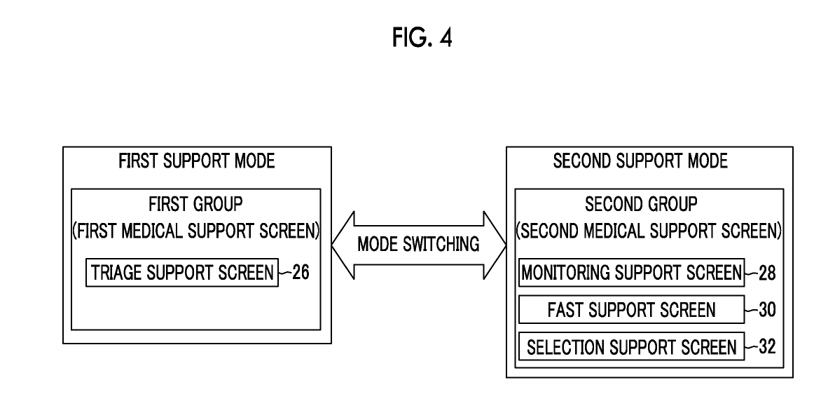

As illustrated in FIG. 4, the mode switching unit 66 performs switching of an operation mode of the display control unit 68 based on the state detection signal input from the attachment and detachment detection unit 64. Two operation modes including a first support mode and a second support mode are provided as the operation modes of the display control unit 68. The mode switching unit 66 operates the display control unit 68 in the first operation mode when the medical support device 16 is in a detachment state, and operates the display control unit 68 in the second operation mode when the medical support device 16 is in the attachment state. Further, when the state of the medical support device 16 is switched between the attachment state and the detachment state during the operation of the display control unit 68, the mode switching unit 66 switches the operation mode of the display control unit 68 according to the switching of the state of the medical support device 16.

Executable support functions are different between the first support mode and the second support mode. Therefore, medical support screens displayed on the display 24 by the display control unit 68 are different between the first support mode and the second support mode according to the support functions. As illustrated in FIG. 4, in the first support mode, a first medical support screen belonging to a first group is displayed corresponding to the support function in the first support mode, whereas in the second support mode, a second medical support screen belonging to a second group is displayed corresponding to the support function in the second support mode. The first medical support screen and the second medical support screen are grouped in advance according to the support functions of the first support mode and the second support mode. Each medical support screen is stored in the storage device 42.

The first support mode is an operation mode of performing support of primary treatment that is performed at a site where an accident or disaster occurs, and the support function of the first support mode is a triage support function in this embodiment. In this example, the first medical support screen is a triage support screen 26 for realizing the triage support function (also see FIG. 3). The display control unit 68 reads the triage support screen 26 from the storage device 42 according to an operation in the first support mode or switching to the first support mode, and displays the triage support screen 26 on the display 24.

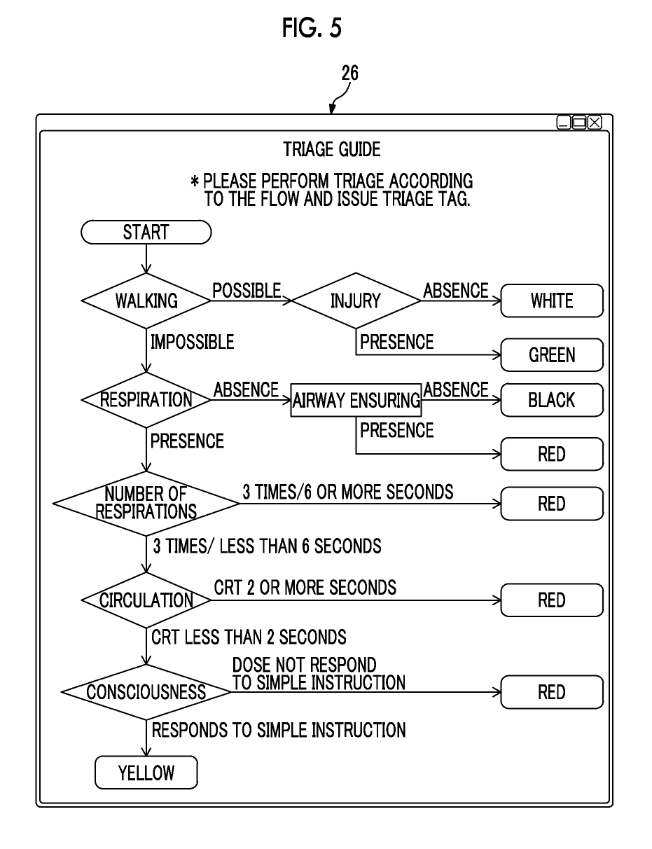

As illustrated in FIG. 5, the triage support screen 26 guides the triage by showing a flowchart of a triage procedure. In the triage, a degree of emergency or a degree of severity of disease or injury is determined for each patient, and a priority of treatment such as curing is determined. A triage tag with different colors such as white, green, yellow, red, and black is imparted to the patient according to the priority. In a flowchart of the triage procedure displayed on the triage support screen 26, steps of determining a degree of emergency or a degree of severity for determining the priority are shown as a chart. A user of the medical support device 16 such as a paramedic who performs the triage determines the priority for each patient while referring to the flowchart of the triage procedure, and issues the triage tag with the color corresponding to the determined priority.

The triage support screen 26 is one image of which the display content is not updated so as to omit a selection operation of a user, a screen updating process based on the selection operation, communication with another device, a screen updating process based on information obtained by the communication, or the like and realize rapid triage. That is, the triage support screen 26 is a non-updatable screen in which only predetermined content is displayed, and display content of the screen is not updated regardless of the presence or absence of reception of new information, such as an input of information by a selection operation or the like.

Thus, the first support mode is an operation mode in which support (support of the triage in this embodiment) of the primary treatment performed at the site where the accident or the disaster occurs, that is, a dispatch destination of an ambulance at which emergency medical care is first required is performed. Therefore, in the first support mode, executable support functions are limited to the minimal amount of necessary functions, and the executable support functions are limited as compared to those in the second support mode to be described below. The second support mode is an operation mode in which support of secondary treatment that is performed while a patient subjected to the primary treatment is being transported by the ambulance from the occurrence site to a medical facility capable of a full-blown treatment such as surgery is performed after the primary treatment.

The support functions of the second support mode include a monitoring function of monitoring vital information, a focused assessment with sonography for trauma (FAST: quick and simple ultrasonic inspection method in initial diagnosis of trauma) support function, and a transport destination selection support function in this embodiment. In this example, the second medical support screen is a screen for use in a support function of the second support mode. Specifically, the second medical support screen includes a monitoring support screen 28 for use in heart rate monitoring which is one piece of vital information, a FAST support screen 30 for use in FAST support, and a selection support screen 32 for use in transport destination selection support. Here, the FAST is an inspection for performing ultrasonic inspection on pericardial space, Morrison fossa, right thoracic cavity, surroundings of the spleen, left thoracic cavity, and Douglas fossa, and determining a need for subsequent treatment (for example, whether or not laparotomy is necessary) based on, for example, the presence or absence of internal bleeding or a portion thereof detected by ultrasonic inspection.

In the second support mode, the display control unit 68 displays any one of a plurality of second medical support screens (the monitoring support screen 28, the FAST support screen 30, and the transport destination selection support screen 32) in the second group on the display 24. The second medical support screen is different from the first medical support screen. As shown below, the second medical support screen is an updatable screen in which display content of the screen is updated based on information received upon each reception of new information from the outside, such as a signal input from the electrocardiograph 12 or an operation input by a selection operation.

An example in which the monitoring support screen 28 among the second medical support screens in the second group is set as an initial screen, and the display control unit 68 reads the initial screen, that is, the monitoring support screen 28 from the storage device 42 according to an operation in the second support mode or switching to the second support mode, and displays the monitoring support screen 28 on the display 24 in this embodiment will be described.

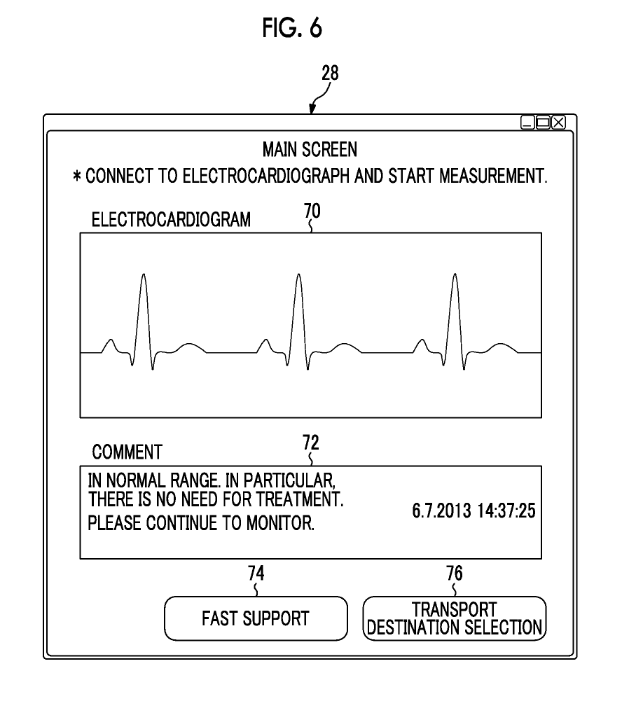

As illustrated in FIG. 6, an electrocardiogram display portion 70 in which a heart rate state is displayed, and a comment display portion 72 are provided in the monitoring support screen 28. In the electrocardiogram display portion 70, an electrocardiogram obtained by the electrocardiograph 12 is displayed. The display control unit 68 displays a waveform of a signal transmitted from the electrocardiograph 12, that is, an electrocardiogram in the electrocardiogram display portion 70. The electrocardiogram is updated in real time each time the signal from the electrocardiograph 12 is transmitted.

Further, the display control unit 68 compares the waveform of the electrocardiogram with a previously prepared sample waveform at a predetermined cycle and displays, for example, a comparison result such as whether or not the waveform of the electrocardiogram of the patient is a normal waveform in the comment display portion 72. A plurality of types of messages to be displayed in the comment display portion 72 are stored in the storage device 42, and the display control unit 68 reads the message closest to the comparison result from the storage device 42, and displays the read message in the comment display portion 72 along with a comparison date and time.

Thus, in the monitoring support screen 28, the electrocardiogram display portion 70 and the comment display portion 72 are displayed and, accordingly, monitoring of vital information (in this embodiment, heart rate) of a patient that is being transported by the ambulance 15 is supported. The vital information for supporting the monitoring in the monitoring support screen 28 is not limited to the electrocardiogram, and may also be vital information other than the electrocardiogram measured by a measurement device such as a blood pressure meter other than the electrocardiograph. Of course, monitoring of a plurality of vital information may be supported, or the user may be caused to select a type of vital information for supporting the monitoring through a touch operation or the like.

In the monitoring support screen 28, a FAST support button 74 and a transport destination selection button 76 are provided, in addition to the electrocardiogram display portion 70 and the comment display portion 72 described above. When the FAST support button 74 is operated in the monitoring support screen 28, the display control unit 68 reads the FAST support screen 30 from the storage device 42 and displays the FAST support screen 30 on the display 24. Further, when the transport destination selection button 76 is operated in the monitoring support screen 28, the display control unit 68 reads the selection support screen 32 from the storage device 42 and displays the selection support screen 32 on the display 24.

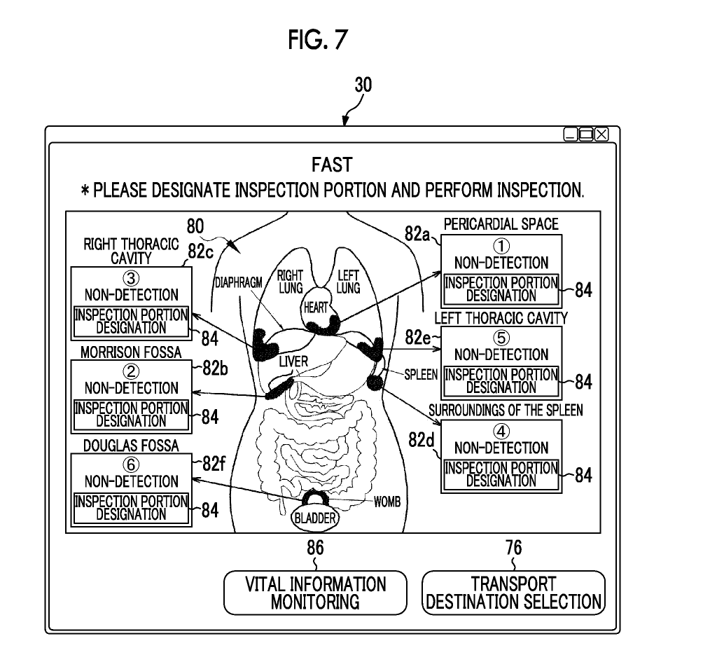

As illustrated in FIG. 7, a schema image 80, and inspection situation display portions 82a to 82f are arranged in the FAST support screen 30. The schema image 80 is an image schematically showing anatomical features of a human body. Six inspection portions to be inspected through the FAST, such as “pericardial space”, “Morrison fossa”, “right thoracic cavity”, “surroundings of the spleen”, “left thoracic cavity”, and “Douglas fossa”, are marked by hatching.

The respective inspection situation display portions 82a to 82f correspond to any of the six inspection portions to be inspected through the FAST. In the FAST support screen 30, in order to show a correspondence relationship therebetween, the inspection situation display portions are connected to the corresponding inspection portions by arrow indicators. When the corresponding inspection portion has not been inspected, a number indicating an inspection order, a message indicating non-inspection, and an inspection portion designation button 84 for designating the inspection portion when the inspection is performed are displayed in each of the inspection situation display portions 82a to 82f. Meanwhile, when inspection of the corresponding portion is executed and the ultrasonic image is transmitted from the ultrasonic inspection device 14, the transmitted ultrasonic image is displayed in the respective inspection situation display portions 82a to 82f.

When the inspection portion designation button 84 is operated, the display control unit 68 enters an ultrasonic image input standby state. When the ultrasonic image is input from the ultrasonic inspection device 14, the display control unit 68 displays the input ultrasonic image in the inspection situation display portion in which the operated inspection portion designation button 84 is arranged, thereby updating the FAST support screen 30.

Thus, in the FAST support screen 30, since the inspection portions are shown by hatching in the schema image 80, the inspection portion can be recognized at a glance. Further, in the FAST support screen 30, completion of the inspection, and an order of the inspection in the case of non-inspection can be recognized by confirming the inspection situation display portions 82a to 82f.

Further, a vital information monitoring button 86 and a transport destination selection button 76 are provided in the FAST support screen 30, in addition to the schema image 80 and the inspection situation display portions 82a to 82f described above. The display control unit 68 reads the monitoring support screen 28 from the storage device 42 and displays the monitoring support screen 28 on the display 24 when the vital information monitoring button 86 is operated in the FAST support screen 30, and reads the selection support screen 32 from the storage device 42 and displays the selection support screen 32 on the display 24 when the transport destination selection button 76 is operated.

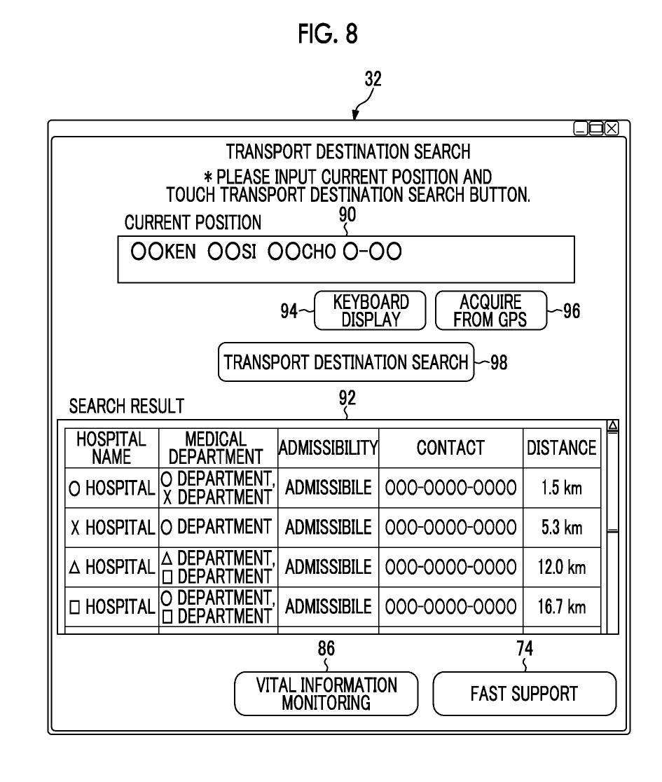

As illustrated in FIG. 8, a current position input portion 90 and a search result display portion 92 are provided in the selection support screen 32. The current position input portion 90 is an input column for inputting a current position. A keyboard display button 94 is operated so as to display a keyboard, and the current position can be manually input through the keyboard. When a position information acquisition button 96 is operated, the position information acquired by the position detection unit 62 can be automatically input.

When a transport destination search button 98 is operated after the current position is input, the display control unit 68 rearranges transport destination candidates in order of closeness to the current position from among pre-registered transport destination candidates (medical facilities that receive emergency transport) to generate a list of transport destination candidates, and displays this list in the search result display portion 92. Further, in the example illustrated in FIG. 8, a name of a medical department installed in each medical facility, a situation of available beds (information indicating whether or not a patient is admissible, a contact, and a distance from the current position are displayed, in addition to a medical facility name (hospital name) of the transport destination candidates.

Thus, in the selection support screen 32, the transport destination candidates can be searched based on the current position, and the medical facility for transport can be selected based on a result of the search. Information on the transport destination candidates may be registered in the medical support device 16 or may be registered in an external terminal connected to the medical support device 16, such as the management center 20. When the information on the transport destination candidates is registered in the external terminal, the medical support device 16 may access the external terminal and acquire or use the information on the transport destination candidates to perform the search (generation of the list of transport destination candidates). Further, the current position information may be transmitted from the medical support device 16 to the external terminal, the search may be performed in the external terminal, and the external terminal may notify the medical support device 16 of a result of the search.

Further, a vital information monitoring button 86 and a FAST support button 74 are provided in the selection support screen 32, in addition to the current position input portion 90 and the search result display portion 92 described above. When the vital information monitoring button 86 is operated in the selection support screen 32, the display control unit 68 reads the monitoring support screen 28 from the storage device 42 and displays the monitoring support screen 28 on the display 24. When the FAST support button 74 is operated, the display control unit 68 reads the FAST support screen 30 from the storage device 42 and displays the FAST support screen 30 on the display 24.

According to the above configuration, since the first medical support screen for supporting the primary treatment is displayed in the first support mode, and the second medical support screen for supporting the secondary treatment, such as the monitoring support screen 28, is displayed in the second support mode, as in the triage support screen 26, that is, different support functions are executed in the primary treatment and the secondary treatment, appropriate support in consideration of a difference in nature between the primary treatment and the secondary treatment can be performed.

Further, according to the present invention, mode switching is convenient since the medical support device is switched to the first support mode by being detached from the cradle device installed inside the ambulance, and the medical support device is switched to the second support mode by being attached to the cradle device. In particular, the primary treatment is often performed outside the ambulance at a dispatch destination (a site where an accident, disaster, or the like occurs) of the ambulance in which the emergency medical care is first required. Further, the secondary treatment is often performed inside the ambulance during transport in the ambulance. Therefore, according to the present invention in which when the medical support device is detached from the cradle, the medical support device is switched to the first support mode in which the primary treatment is automatically supported, and when the medical support device is attached to the cradle, the medical support device is switched to the second support mode in which the second treatment is automatically supported, it is not necessary to manually switch the support mode. Accordingly, rapid primary treatment or secondary treatment can be realized.

Further, according to the present invention, since the first medical support screen (triage support screen 26) supporting the primary treatment is a non-updatable screen, time and effort of an updating process or an input for updating are reduced, and rapid primary treatment is realized. Meanwhile, in the present invention, since the second medical support screen of which the display content is updated based on information input from an external terminal (for example, an inspection device such as an electrocardiogram or an ultrasonic inspection device, or a management center) is updated in the secondary treatment, generous support can be realized.

In the present invention, since the first medical support screen belonging to the first group may be displayed in the first support mode, and the second medical support screen belonging to the second group may be displayed in the second support mode, other detailed configurations can be appropriately changed. For example, while the example in which operation modes of the medical support device are switched with attachment and detachment of the medical support device to and from the cradle device has been described in the above-described embodiment, a mode switching button may be displayed on the display and the operating mode of the medical support device may be switched with an operation of the mode switching button.

Further, a medical support screen supporting life-saving treatment such as artificial respiration or heart massage may be set as the first medical support screen belonging to the first group. Further, a support screen supporting X-ray inspection using an X-ray imaging device may be set as the second medical support screen belonging to the second group. Of course, medical support screens belonging to the first and second groups are not limited thereto and can be appropriately added and modified.

Further, while the example in which the first medical support screens in the first group and the second medical support screens in the second group do not overlap each other has been described in the above-described embodiment, the first medical support screen and the second medical support screen may overlap each other, for example, such that the triage support screen 26 can be used as the second medical support screen, as well as the first medical support screen. However, when the second medical support screens are caused to belong to the first group, support functions provided in the first support mode are needlessly added, and rapid treatment required in the first support mode may be obstructed. On the other hand, in the second support mode, multiple functions are required, unlike the first support mode. Therefore, when the first medical support screen and the second medical support screen overlap each other, a method of realizing multiple support functions supplied in the second support mode by causing the first medical support screens to belong to the second group is preferable.

Further, when the first medical support screen and the second medical support screen overlap each other, support functions provided by the overlapping medical support screens may be different between the first support mode and the second support mode. In this case, for example, it is considered that the FAST support screen may be caused to belong to both the first group and the second group, the FAST support screen 30 as in FIG. 7 described above, that is, a medical support screen having a function of updating the inspection situation display portions 82a to 82f may be displayed in the second support mode, and a medical support screen in which the function of updating the display of the inspection situation display portions 82a to 82f has been discarded may be displayed in the first support mode. By doing so, a support function of identifying an inspected portion and a non-inspected portion based on whether an ultrasonic image is displayed in the inspection situation display portions 82a to 82f is limited in the first support mode, but a support function of displaying a portion to be inspected through FAST can be provided. Further, in the first support mode, it is possible to realize rapid FAST by not updating the inspection situation display portions 82a to 82f.

Further, while the example in which the medical support device is the tablet computer has been described in the above-described embodiment, the medical support device may be a smart phone or a laptop computer. Further, some devices used as the medical support device have a camera function. When the device having the camera function is used as the medical support device like this, a support function of supporting emergency medical care can be added using the camera function.

For example, it is considered, as an emergency medical support function using the camera function, that an image of an occurrence site of an accident or disaster in which emergency medical care is first required is captured at the occurrence site in the first support mode, and an image of a patient inside the ambulance is captured in the second support mode. It may be considered that the captured image, for example, is attached to an electronic triage tag in the first support mode, and is attached to an electronic chart together with, for example, progress of treatment performed inside the ambulance in the second support mode. Further, the captured image may be stored in the medical support device or may be distributed to a management center.

A type (traffic accident, fire, water accident, drug accident (for example, chemical disaster), or the like) of an accident or disaster or nature (scale, surrounding environment, season, time, or the like) can be inferred from the image of the occurrence site. Further, a state of a patient and a change in the state can be observed from the image of the patient inside the ambulance. Therefore, more generous support can be realized by supporting the emergency medical care using the camera function.

The operation mode of the camera may be switched with the attachment to and detachment from the cradle device. In this case, for example, it is considered that when the medical support device is detached from the cradle device, the camera is operated in a mode in which a still image is photographed, and when the medical support device is attached to the cradle device, the camera is operated in a mode in which a moving image is photographed. Further, when the medical support device is detached from the cradle device, the camera may be operated in a mode of performing photographing in response to an operation of a shutter button, and when the medical support device is attached to the cradle device, the camera may be operated in a mode of automatically performing photographing regardless of the operation of the shutter button (always performing capturing of a moving image or repeating still image capturing at a predetermined cycle).

Further, a device used as the medical support device may include a device including two cameras: a front camera that photographs a display side, and a rear camera that photographs a rear side opposite to the display. It is considered that, when the medical support device includes the two cameras like this, the medical support device is operated in a mode in which photographing is performed using the rear camera (that is, a mode in which the user grips the medical support device and that is suitable for photographing the site where an accident or disaster occurs) in the first support mode, and operated in a mode in which photographing is performed using the front camera (that is, a mode in which the medical support device is set in the cradle device, and the user can photograph the inside of the ambulance while observing the medical support screen displayed on the display) in the second support mode.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A portable medical support device that supports emergency medical care, the medical support device comprising:
a display control unit for displaying a medical support screen for supporting the emergency medical care on a display, the display control unit performing control for displaying any one of a plurality of medical support screens grouped into first and second groups in advance; and
a mode switching unit for switching an operation mode between a first support mode of displaying a first medical support screen that is the medical support screen belonging to the first group and a second support mode of displaying a second medical support screen that is the medical support screen belonging to the second group.

2. The medical support device according to claim 1, wherein treatment in the emergency medical care is classified into primary treatment and secondary treatment executed after the primary treatment, a medical support screen necessary for the primary treatment is set as the first medical support screen, and a medical support screen necessary for the secondary treatment is set as the second medical support screen.

3. The medical support device according to claim 2, wherein the primary treatment is treatment that is performed at a dispatch destination of an ambulance in which the emergency medical care is first required.

4. The medical support device according to claim 2, wherein the secondary treatment is treatment that is performed while a patient subjected to the primary treatment is transported to a medical facility by an ambulance.

5. The medical support device according to claim 3, which is detachably provided in the cradle device installed inside the ambulance, further comprising an attachment and detachment detection unit that detects attachment and detachment of the medical support device to and from the cradle device, wherein
the mode switching unit performs switching of the operation mode in accordance with the attachment and detachment of the medical support device to and from the cradle device.

6. The medical support device according to claim 5, wherein the mode switching unit switches the operation mode to the first support mode in the case where the medical support device is detached from the cradle device, and switches the operation mode to the second support mode in the case where the medical support device is attached to the cradle device.

7. The medical support device according to claim 1, wherein the first medical support screen includes a medical support screen for supporting triage for determining a priority of treatment of a patient.

8. The medical support device according to claim 1, wherein the first medical support screen includes a medical support screen for supporting life-saving treatment of a patient.

9. The medical support device according to claim 1, wherein the second medical support screen includes a monitoring support screen for supporting monitoring of vital information of a patient.

10. The medical support device according to claim 9, which is capable of receiving the vital information transmitted from a measurement device for measuring the vital information, wherein
the display control unit updates the monitoring support screen based on the received vital information.

11. The medical support device according to claim 1, wherein the second medical support screen includes a FAST support screen for supporting FAST that is a quick and simple inspection method performed using an ultrasonic inspection device.

12. The medical support device according to claim 11, wherein the FAST support screen is a screen, in which positions of six places including pericardial space, Morrison fossa, right thoracic cavity, surroundings of the spleen, left thoracic cavity, and Douglas fossa that are inspection portions in the FAST are marked in a schema diagram as a schematic diagram of a human body.

13. The medical support device according to claim 12, which is capable of receiving an ultrasonic image from the ultrasonic inspection device, wherein
the display control unit displays the received ultrasonic image on the FAST support screen.

14. The medical support device according to claim 1, wherein the second medical support screen includes a selection support screen for supporting selection of a medical facility as a transport destination.

15. The medical support device according to claim 14, further comprising a position detection unit for receiving radio waves from a GPS satellite so as to acquire current position information, wherein
the display control unit displays a selectable medical facility on the selection support screen based on the current position information acquired by the position detection unit.

16. The medical support device according to claim 1, wherein
the first medical support screen is a non-updatable screen in which display content of the screen is not updated regardless of whether or not new information is received, and
the second medical support screen is an updatable screen in which display content of the screen is updated based on received information each time new information is received.

17. The medical support device according to claim 1, further comprising a camera for photographing a site of a dispatch destination of an ambulance in which the emergency medical care is first required in the first support mode, and photographing a patient that is being transported to a medical facility by the ambulance in the second support mode.

18. The medical support device according to claim 1, wherein at least some of the first medical support screens belonging to the first group are set in the second group in an overlapping manner.

19. The medical support device according to claim 1, wherein executable support functions are limited in the first support mode more than in the second support mode.
